(19) United States
(12) Patent Application Publication
(10) Pub. No.: US 2025/0211345 A1
(43) Pub. Date: Jun. 26, 2025

(54) METHODS, COMMUNICATIONS DEVICES, AND NETWORK INFRASTRUCTURE EQUIPMENT

(71) Applicant: Sony Group Corporation, Tokyo (JP)

(72) Inventor: Shin Horng WONG, Basingstoke (GB)

(73) Assignee: Sony Group Corporation, Tokyo (JP)

(21) Appl. No.: 18/848,132

(22) PCT Filed: Mar. 9, 2023
(86) PCT No.: PCT/EP2023/056068

§ 371 Date: Sep. 18, 2024

(30) Foreign Application Priority Data
Mar. 30, 2022 (EP) 22165603.6

(51) Int. Cl. H04B 17/309; H04B 7/06; H04L 5/00; H04W 28/26

(52) U.S. Cl. CPC H04B 17/346; H04B 7/0632; H04L 5/0051; H04W 28/26

(57) ABSTRACT

Methods and apparatus for measuring a level of interference at a communications device. A communications device receives a first reference signal and one or more second reference signals, wherein the first reference signal is received from another communications device, and measures a level of interference of the first reference signal and one or more second reference signals. The indication of the level of interference is transmitted by the communications device to the infrastructure equipment, where scheduling decisions are made based on the level of interference.

The present application claims the Paris Convention priority of European patent application EP22165603.6, filed 30 Mar. 2022, the contents of which are hereby incorporated by reference.

### BACKGROUND

### Field of Disclosure

The present disclosure relates to a communications device, network infrastructure equipment and methods of operating a communications device to receive data from a wireless communications network.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Modern mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Wireless communications networks are expected to routinely and efficiently support communications with an ever-increasing range of devices associated with a wide range of data traffic profiles and types. For example, it is expected that wireless communications networks efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is a desire for current generation wireless communications networks, for example those referred to as 5G or new radio (NR) systems/new radio access technology (RAT) systems, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is enhanced Mobile Broadband (eMBB) services, which are characterised by a high capacity with a requirement to support up to 20 Gb/s. URLLC and eMBB type services therefore represent challenging examples for both LTE type communications systems and 5G/NR communications systems.

5G NR has continuously evolved and the current agenda includes 5G-NR-advanced in which some further enhancements are expected, especially to support new use-cases/scenarios with higher requirements. The desire to support these new use-cases and scenarios gives rise to new challenges for efficiently handling communications in wireless communications systems that need to be addressed.

### SUMMARY OF THE DISCLOSURE

The present disclosure can help address or mitigate at least some of the issues discussed above.

According to a first aspect there is provided a method for a communications device, the method comprising: receiving a first reference signal and one or more second reference signals, wherein the first reference signal is received from another communications device; measuring a level of interference of the first reference signal and the one or more second reference signals; and transmitting, to an infrastructure equipment, an indication of the level of interference.

According to a second aspect there is provided a method for an infrastructure equipment, the method comprising: receiving, from a first communications device, an indication of a level of interference of a first reference signal and one or more second reference signals, wherein the first reference signal transmitted by a second communications device; and scheduling one or more of the first communications device and the second communications device based on the received indication of the level of interference.

According to a third aspect there is provided a method for a communications device, the method comprising: receiving, from an infrastructure equipment, an instruction to transmit a first reference signal; and transmitting the first reference signal for use by another communications device for measuring a level of interference between the first reference signal one or more second reference signals.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 schematically illustrates an example of inter-cell cross link interference.

FIG. 5 illustrates an example approach for accounting for inter-cell cross link interference.

FIG. 6 schematically illustrates an example of intra-cell cross link interference

FIG. 7 illustrates an example division of system bandwidth into dedicated uplink and downlink sub-bands.

FIG. 8 illustrates an example of transmission power leakage.

FIG. 9 illustrates an example of receiver power selectivity.

FIG. 10 illustrates adjacent channel interference.

FIG. 11 schematically illustrates an example approach for measuring adjacent channel interference.

FIG. 12 illustrates the processes of the example of FIG. 11 for measuring adjacent channel interference.

FIG. 13 illustrates the division of system bandwidth into multiple frequency blocks for measuring adjacent channel interference.

FIG. 14 illustrates an example measurement of adjacent channel interference in frequency blocks using signal to noise plus interference ratio measurement.

FIG. 15 illustrates an example division of system bandwidth into frequency blocks of varying size.

FIG. 16 schematically illustrates an example approach for measuring adjacent channel interference.

FIG. 17 illustrates the processes of the example of FIG. 16 for measuring adjacent channel interference.

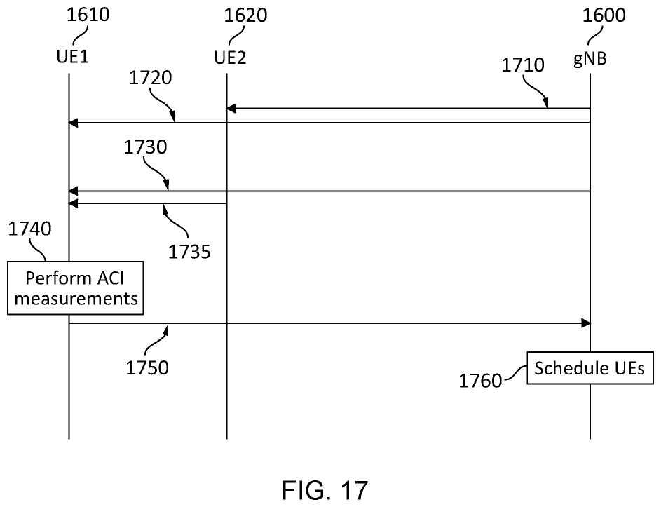

FIG. 18 illustrates a flow diagram of an example method for a communications device according to the present disclosure.

FIG. 19 illustrates a flow diagram of an example method for an infrastructure equipment according to the present disclosure.

FIG. 20 illustrates a flow diagram of an example method for a communications device according to the present disclosure.

### DETAILED DESCRIPTION OF THE EMBODIMENTS

### Long Term Evolution Advanced Radio Access Technology (4G)

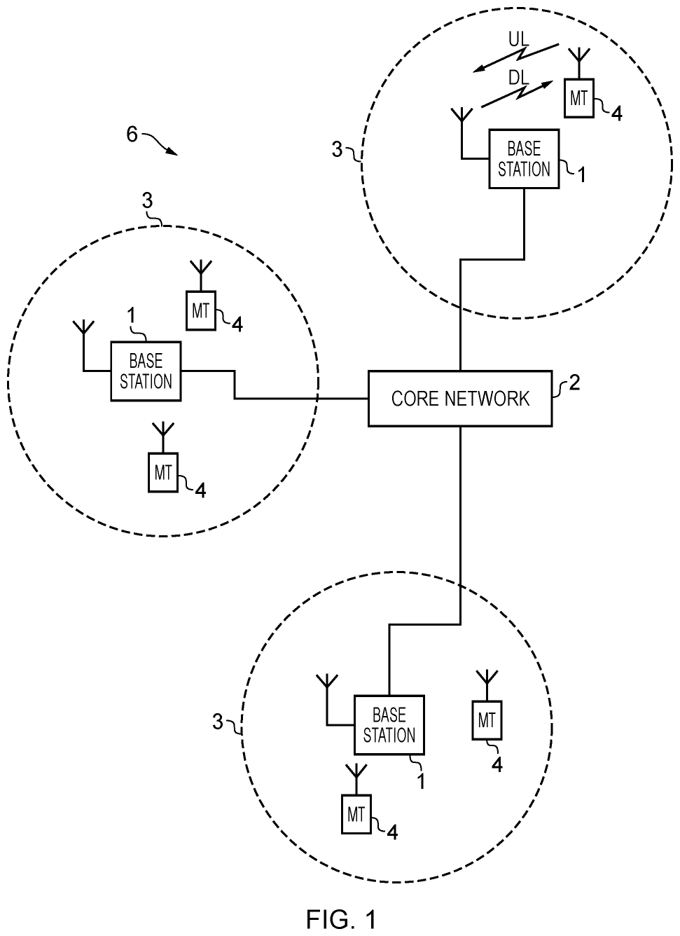

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices or mobile terminals (MT) 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. The communications or terminal devices 4 may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G (NR))

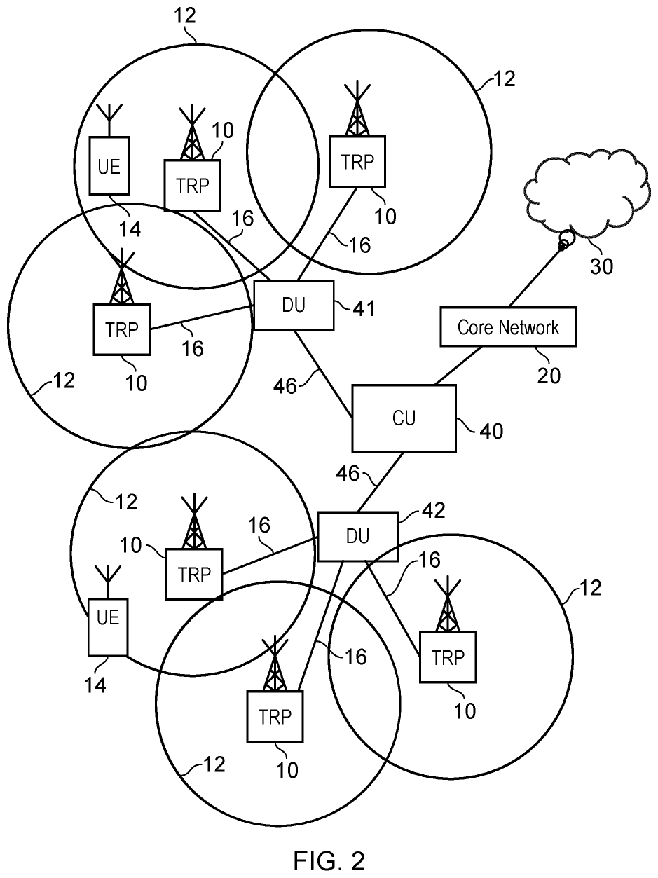

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

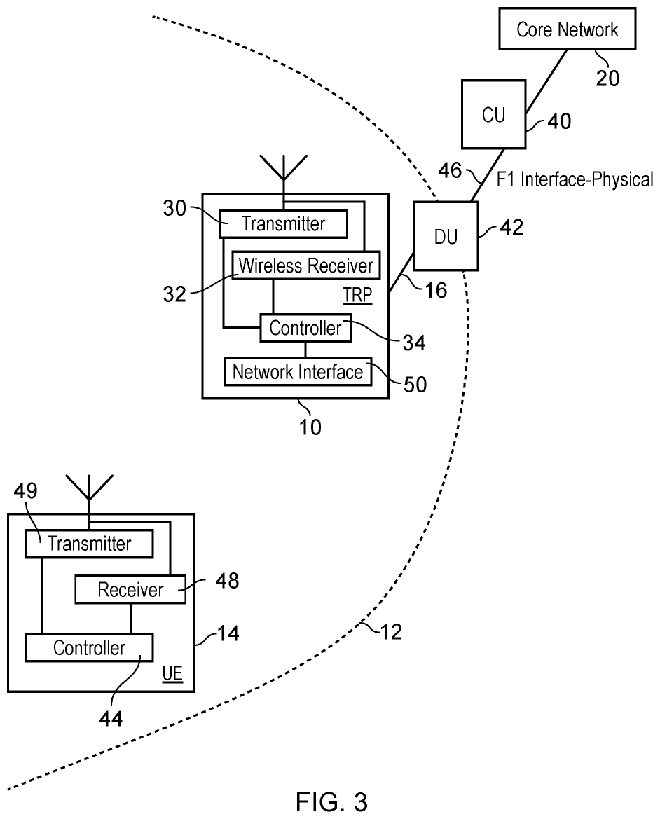

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter circuit 49, a receiver circuit 48 and a controller circuit 44 which is configured to control the transmitter circuit 49 and the receiver circuit 48 to transmit signals representing uplink data to the wireless communications network via the wireless access interface formed by the TRP 10 and to receive downlink data as signals transmitted by the transmitter circuit 30 and received by the receiver circuit 48 in accordance with the conventional operation.

The transmitter circuits 30, 49 and the receiver circuits 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controller circuits 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

### Full Duplex Time Division Duplex (FD-TDD)

NR/5G networks can operate using Time Division Duplex (TDD), where an entire frequency band is switched to either downlink or uplink transmissions for a time period and can switched to the other of downlink or uplink transmissions at a later time period. Currently, TDD operates in Half Duplex mode (HD-TDD) where the gNB or UE can, at a given time, either transmit or receive packets, but not both at the same time. As wireless networks transition from NR to 5G-Advanced networks, a proposed new feature of such networks is to enhance duplexing operation for Time Division Multiplexing (TDD) by enabling Full Duplex operation in TDD (FD-TDD) [2]. In FD-TDD, a gNB can transmit and receive data to and from the UEs at the same time on the same frequency band. In addition, a UE can operate either in HD-TDD or FD-TDD mode, depending on its capability. For example, when UEs are only capable of supporting HD-TDD, FD-TDD is achieved at the gNB by scheduling a DL transmission to a first UE and scheduling an UL transmission from a second UE within the same orthogonal frequency division multiplexing (OFDM) symbol (i.e. at the same time). Conversely, when UEs are capable of supporting FD-TDD, FD-TDD is achieved both at the gNB and the UE, where the gNB can simultaneously schedule this UE with DL and UL transmissions within the same OFDM symbol by scheduling the DL and UL transmissions at different frequencies (e.g. physical resource blocks (PRBs)) of the system bandwidth. A UE supporting FD-TDD requires more complex hardware than a UE that only supports HD-TDD, development of current 5G networks is focused primarily on enabling FD-TDD at the gNB with UEs operating in HD-TDD mode.

Motivations for enhancing duplexing operation for TDD include an improvement in system capacity, reduced latency, and improved uplink coverage. For example, in current HD-TDD systems, slots are allocated only for either an DL or UL direction in a semi-static manner. Hence, if one direction experiences less or no data, the spare resources cannot be used in the other direction, or are, at best, under-utilized. However, if resources can be used for either DL data or UL data (as in FD-TDD), the resource utilization in the system can be improved. Furthermore, in current HD-TDD systems, a UE can receive DL data, but cannot transmit UL data at the same time, which causes delays. If a gNB or UE is allowed to transmit and receive data at the same time (as with FD-TDD), the traffic latency will be improved. In addition, UEs are usually limited in the UL transmissions when located close to the edge of a cell. While the UE coverage at the cell-edge can be improved if more time domain resources are assigned to UL transmissions (e.g. repetitions), if the UL direction is assigned more time resources, fewer time resources can be assigned to the DL direction, which can lead to system imbalance. Enabling FD-TDD would help allow a UE to be assigned more UL time resources when required, without sacrificing DL time resources.

### Inter-Cell Cross Link Interference (CLI)

In NR systems, a slot format (i.e. the allocation of DL and UL OFDM symbols in a slot) can be semi-statically or dynamically configured, where each OFDM symbol (OS) in a slot can be configured as Downlink (DL), Uplink (UL) or Flexible (F). An OFDM symbol that is semi-statically configured to be Flexible can be indicated dynamically as DL, UL or remain as Flexible by a Dynamic Slot Format Indicator (SFI), which is transmitted in a Group Common (GC) DCI using DCI Format 2_0, where the CRC of the GC-DCI is masked with SFI-RNTI. Flexible OFDM Symbols that remain Flexible after instruction from the SFI can be changed to a DL symbol or a UL symbol by a DL Grant or a UL Grant respectively. That is, a DL Grant scheduling a PDSCH that overlaps Flexible OFDM Symbols would convert these Flexible OFDM Symbols to DL and similarly an UL Grant scheduling a PUSCH that overlaps Flexible OFDM Symbols would convert these Flexible OFDM Symbols to UL.

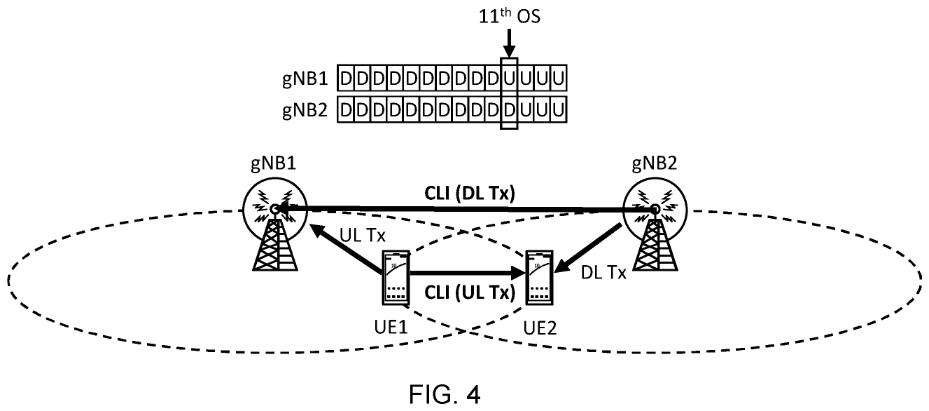

Since each gNB in a network can independently change the configuration of each OFDM symbol, either semi-statically or dynamically, it is possible that in a particular OFDM symbol, one gNB is configured for UL and a neighbour gNB is configured for DL. This causes inter-cell Cross Link Interference (CLI) among the conflicting gNBs. Inter-cell CLI occurs when a UE's UL transmission interferes with a DL reception by another UE in another cell, or when a gNB's DL transmission interferes with an UL reception by another gNB. That is, inter-cell CLI is caused by non-aligned (conflicting) slot formats among neighbouring cells. An example is shown in FIG. 4, where gNB1 and gNB2 have synchronised slots. At a given slot, gNB1's slot format={D, D, D, D, D, D, D, D, D, D, U, U, U, U} whilst gNB2 #s slot format={D, D, D, D, D, D, D, D, D, D, D, U, U, U}, where ‘D’ indicates DL and ‘U’ indicates UL. Inter-cell CLI occurs during the 11th OFDM symbol of the slot, where gNB1 is performing UL whilst gNB2 is performing DL. Specifically, inter-cell CLI occurs between gNB1 & gNB2, where gNB2's DL transmission interferes with gNB1's UL reception. CLI also occurs between UE1 & UE2, where UE1's UL transmission interferes with UE2's DL reception.

Some legacy implementations attempt to reduce inter-cell CLI in TDD networks caused by flexible and dynamic slot format configurations. Two CLI measurement reports to manage and coordinate the scheduling among neighbouring gNBs include: sounding reference signal (SRS) reference signal received power (RSRP) and CLI received signal strength indicator (RSSI). In SRS-RSRP, a linear average of the power contribution of an SRS transmitted by a UE is measured by a UE in a neighbour cell. This is measured over the configured resource elements within the considered measurement frequency bandwidth, in the time resources in the configured measurement occasions. In CLI-RSSI, a linear average of the total received power observed is measured only at certain OFDM symbols of the measurement time resource(s), in the measurement bandwidth, over the configured resource elements for measurement by a UE.

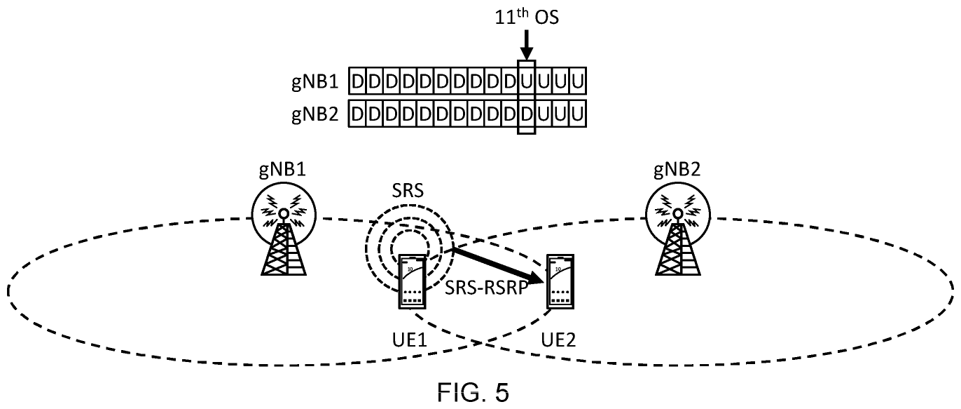

Both SRS-RSRP and CLI-RSSI are RRC measurements and are performed by a UE, for use in mitigating against UE to UE inter-cell CLI. For SRS-RSRP, an aggressor UE (i.e. a UE whose UL transmissions cause interference at another UE in a neighbouring cell) would transmit an SRS in the uplink and a victim UE (i.e. a UE that experiences interference due to an UL transmission from the UE in the neighbouring cell) in a neighbour cell would be configured with a measurement configuration including the aggressor UE's SRS parameters, in order to allow the interference from the aggressor UE to be measured. An example is shown in FIG. 5 where, at a particular slot, the 11^{th} OS of gNB1 and gNB2 causes inter-cell CLI. Here, gNB1 has configured UE1, the aggressor UE, to transmit an SRS and gNB2 has configured UE2, the victim UE, to measure that SRS. UE2 is provided with UE1's SRS configured parameters, e.g. RS sequence used, frequency resource, frequency transmission comb structure & time resources, so that UE2 can measure the SRS. In general, a UE can be configured to monitor 32 different SRSs, at a maximum rate of 8 SRSs per slot.

For CLI-RSSI measurements, the UE measures the total received power, i.e. signal and interference, following a configured periodicity, start & end OFDM symbols of a slot, and a set of frequency Resource Blocks (RBs). Since SRS-RSRP measures a transmission by a specific UE, the network can target a specific aggressor UE to reduce its transmission power and in some cases not schedule the aggressor UE at the same time as a victim UE that reports a high SRS-RSRP measurement. In contrast, CLI-RSSI cannot be used to identify a specific aggressor UE's transmission, but CLI-RSSI does provide an overall estimate of the inter-cell CLI experienced by the victim UE.

### Intra-Cell Cross Link Interference (CLI)

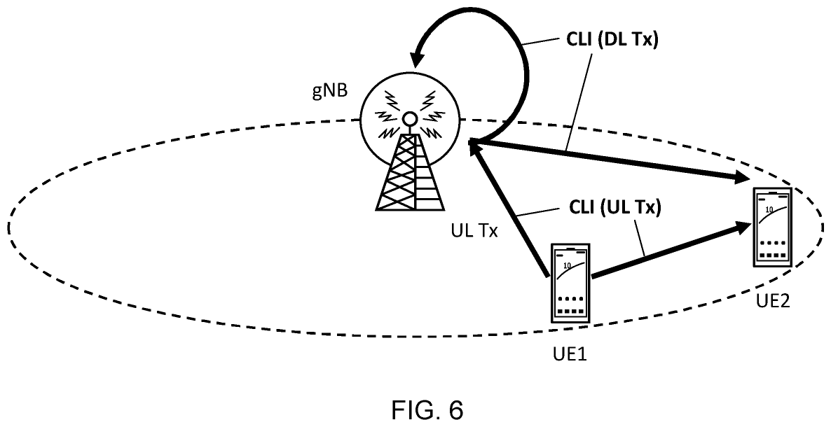

In addition to inter-cell CLI, FD-TDD also suffers from intra-cell CLI at the gNB and at the UE. An example is shown in FIG. 6, where a gNB is capable of FD-TDD and is simultaneously receiving UL transmission from UE1 and transmitting DL transmission to UE2. At gNB1, intra-cell CLI is caused by the DL transmission at the gNB's transmitter self-interfering with its own receiver that is trying to decode UL signals. At the UE, intra-cell CLI is caused by an aggressor UE, e.g. UE1, transmitting in the UL, whilst a victim UE, e.g. UE2, is receiving a DL signal.

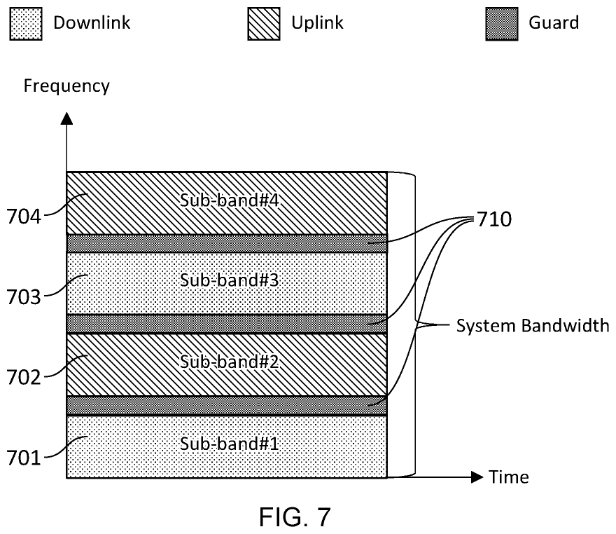

The intra-cell CLI at the gNB due to self-interference can be significant, as the DL transmission can in some cases be over 100 dB more powerful than the UL reception. Accordingly, complex RF hardware and interference cancellation are required to isolate this self-interference. In order to reduce self-interference at the gNB, one possibility is to divide the system (i.e. UE/gnB) bandwidth into non-overlapping sub-bands 701-704, as shown in FIG. 7, where simultaneous DL and UL transmissions occur in different sub-bands 701-704, i.e. in different sets of frequency Resource Blocks (RB).

To reduce leakage from one sub-band 701-704 to another, a guard sub-band 710 maybe configured between UL and DL sub-bands 701-704. An example is shown in FIG. 7, where a TDD system bandwidth is divided into 4 sub-bands 701, 702, 703, 704: Sub-band #1 701, Sub-band #2 702, Sub-band #3 703 and Sub-band #4 704 such that Sub-band #1 701 and Sub-band #3 703 are used for DL transmissions whilst Sub-band #2 702 and Sub-band #4 704 are used for UL transmissions. Guard sub-bands 710 are configured between UL Sub-band #4 704 and DL Sub-band #3 703, between DL Sub-band #3 703 and UL Sub-band #2 702 and between UL Sub-band #2 702 and DL Sub-band #1 701. The arrangement of sub-bands 701-704 shown in FIG. 7 is just one possible arrangement of the sub-bands and other arrangements are possible.

Adjacent channel interference

Although a transmission is typically scheduled within a specific frequency channel, i.e. a specific set of RBs, transmission power can leak out to other channels. This occurs because channel filters are not perfect, and as such the roll-off of the filter will cause power to leak into channels adjacent to the intended specific frequency channel.

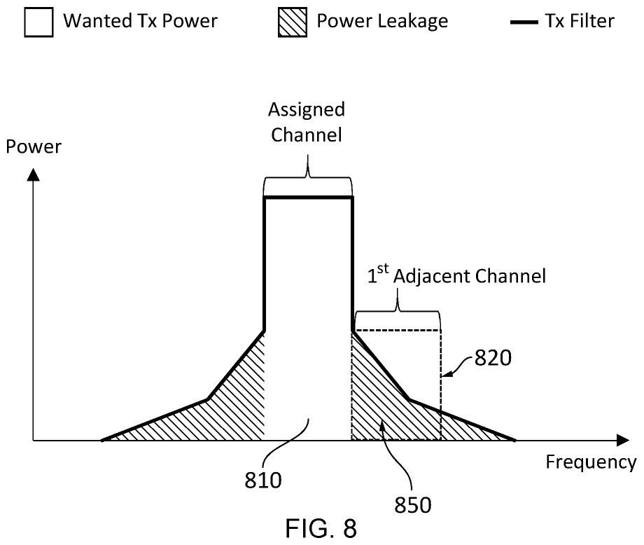

An example of transmission adjacent channel leakage is shown in FIG. 8. Here, the wanted transmission (Tx) power is the transmission power in the selected frequency band (i.e. the assigned channel 810). Due to roll-off of the transmission filter, some transmission power is leaked into adjacent channels (including an adjacent channel 820), as shown in FIG. 8. The ratio of the power within the assigned frequency channel 810 to the power in the adjacent channel 820 is the Adjacent Channel Leakage Ratio (ACLR). The leakage power 850 will cause interference at a receiver that is receiving the signal at the adjacent channels 820.

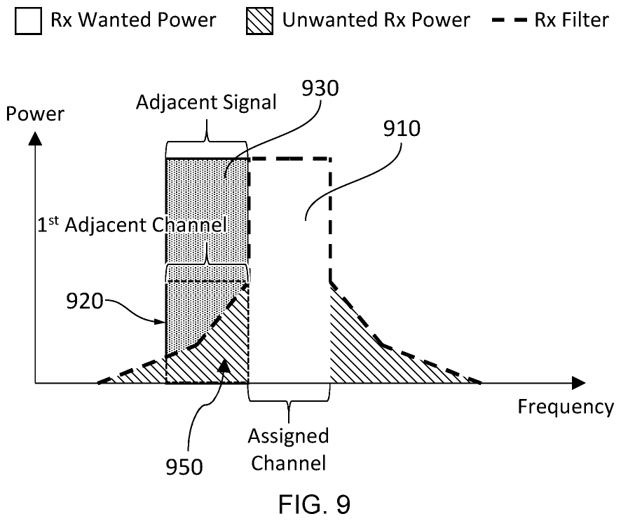

Similarly, a receiver's filter is also not perfect and will receive unwanted power from adjacent channels due to its own filter roll-off. An example of filter roll-off at a receiver is shown in FIG. 9. Here, a receiver is configured to receive transmissions in an assigned channel 910, however the imperfect nature of the receiver filter means that some transmission power 950 can be received in adjacent channels 920. Therefore, if a signal 930 is transmitted on an adjacent channel 920, the receiver will inadvertently receive the adjacent signal 930 in the adjacent channel 920, to an extent. The ratio of the received power in the assigned frequency channel 910 to the received power 950 in the adjacent channel 920 is the Adjacent Channel Selectivity (ACS).

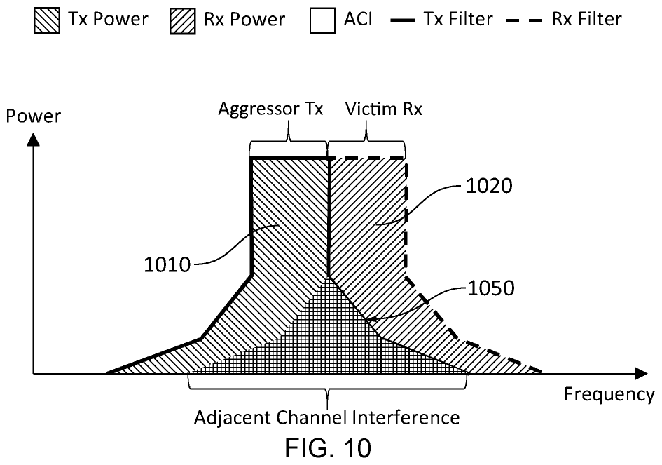

The combination of the ACL from the transmitter and the ACS of a receiver will lead to adjacent channel interference (ACI) at the receiver. An example is shown in FIG. 10, where an aggressor transmits a signal 1010 in an adjacent channel at a lower frequency than the victim's receiving 1020 channel. The interference 1050 caused by the aggressor's transmission includes the ACL of the aggressor's transmitting filter and the ACS of the victim's receiving filter. In other words, the receiver will experience interference 1050 in the ACI frequency range shown in FIG. 10.

As such, due to adjacent channel interference (ACI), cross link interference (CLI) will still occur despite the use of different sub-bands 701-704 for DL and UL transmissions in a FD-TDD cell. The proposed SRS-RSRP and CLI-RSSI measurements specified for inter-cell CLI assume that an aggressor and a victim transmit and receive in the same frequency channel. That is, the measurements for SRS-RSRP and CLI-RSSI at a victim UE are performed in the same frequency channel as the aggressor's frequency channel. These approaches therefore do not take into account ACI and the use of sub-bands 701-704 to provide information for the scheduler to mitigate against intra-cell CLI.

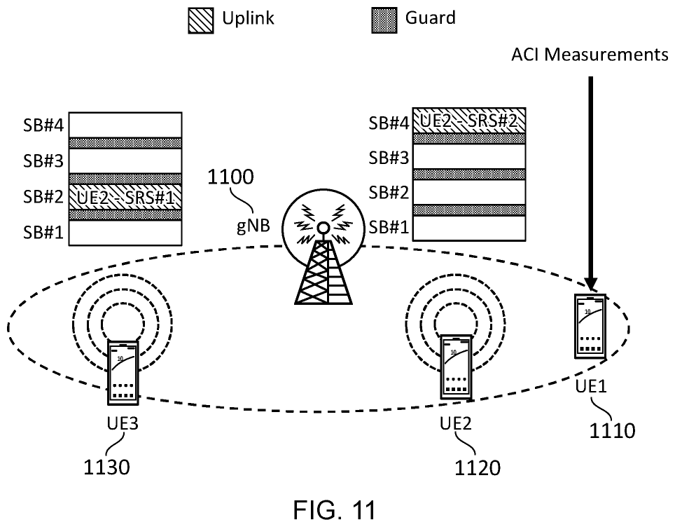

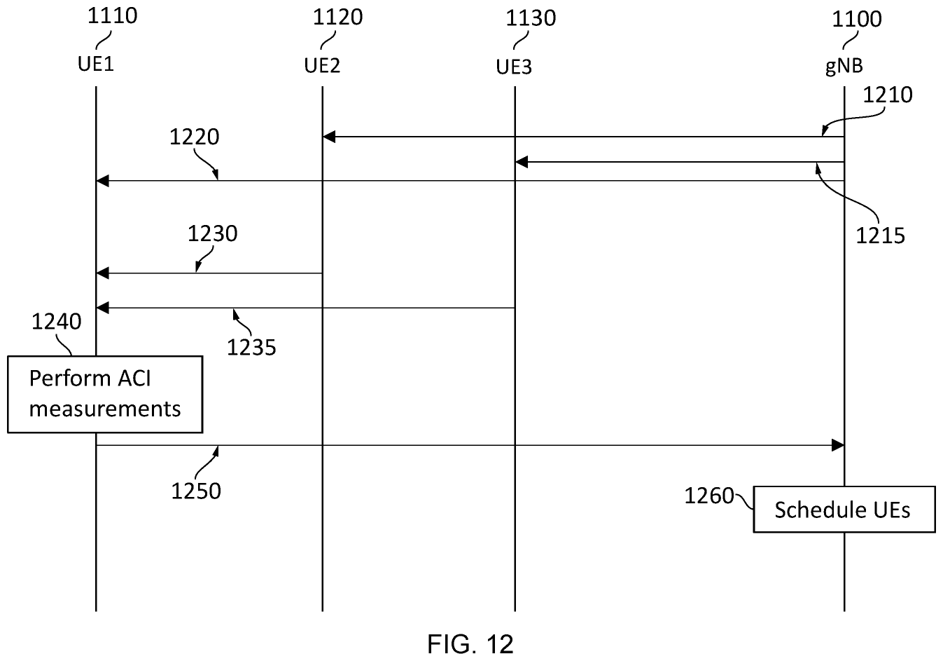

FIG. 11 illustrates an example approach for measuring the effects of ACI at a UE. A gNB 1100 configures UE2 1120 and UE3 1130 to transmit an SRS in sub-band #4 704 and sub-band #2 702 respectively (as shown in FIG. 7). UE1 1110 then determines an extent of ACI by measuring the interference caused by the transmissions by UE2 1120 and UE3 1130 in sub-band #4 704 and sub-band #2 702. In particular, UE1 1110 may determine the level of interference that the transmissions by UE2 1120 and UE3 1130 cause to potential UE1 DL or UL transmissions at UE1 1110. UE1 1110 then reports the results of this measurement to the gNB 1100. FIG. 12 illustrates this process. A gNB 1100 configures 1210 UE2 1120 to transmit an SRS. The configuration may instruct UE2 1120 to transmit the SRS at a particular time and may include additional parameters such as transmission power. The gNB 1100 similarly configures 1215 UE3 1130 to transmit its own SRS. The gNB further configures 1220 UE1 1110 to measure the SRS transmissions from UE2 1120 and UE3 1130. UE2 1120 then begins its SRS transmission 1230 which is received by UE1 1110, and UE3 1130 begins its SRS transmissions 1235 which is received by UE1 1110. UE1 1110 performs ACI measurements 1240 for each of the SRS transmissions 1230, 1235. UE1 1110 may perform the ACI measurements concurrently, or may perform them sequentially. Furthermore, the ACI measurements for one SRS signal may be performed before the other SRS signal has been transmitted and may also be performed before the gNB has configured the other UE to transmit an SRS. As such, the various steps described above can be performed in a number of different orders. After performing the ACI measurements, UE1 1110 transmits the results 1250 of the measurements to the gNB 1100. The gNB then uses the ACI measurement results to determine appropriate scheduling 1260 for particular UEs (i.e. UE1 1110, UE2 1120 and/or UE3 1130). For example, the gNB 1100 may configure UE1 1110 to use a particular sub-band 701-704 for UL transmissions based on the ACI measurements. The gNB 1010 may also determine not to schedule a particular pair of UEs for DL and UL at the same time due to the interference.

The ACI/interference measurements can take a number of forms, for example, the measurement may include a signal to noise plus interference ratio (SNIR) measurement. While UE1 1110 may perform an SNIR measurement, the result of this measurement is used by the gNB 1100 in the opposite manner to conventional SNIR measurement results. In particular, conventionally a gNB would schedule a UE where the SNIR measurement result is (approximately) largest, however as the present example intends to determine a degree of interference caused a particular signal, the gNB 1100 instead schedules a UE where the SNIR measurement result is (approximately) smallest. The interference measurement may also include a channel quality indicator (CQI) measurement. In particular, UE1 1110 may measure a CQI based on the SRS transmissions from UE2 1120 and UE3 1130, rather than doing so based on a channel state information reference signal (CSI-RS) from the gNB 1100. The measurement may also include a received signal strength indicator (RSSI) measurement for the reference signals. Apart from interference, signal quality measurements can also be reported, for example the signal quality measurement can be a

CQI based on the traditional CSI-RS transmitted by the gNB but under the influence of SRS from other UEs, such as UE2 1120 and/or UE3 1130. Here UE1 1110 can be configured to measure CQI at specific times where UE2 1120 and/or UE3 1130 transmit their SRS. Multiple ones of these measurements may be performed by UE1 1110 and reported to the gNB 1100, and the gNB 1100 may take multiple ones of these measurement into account when making scheduling decisions.

Furthermore, the ACI measurements may be reported to the gNB in a number of ways. For example, the ACI measurements may be reported in the physical layer (i.e. Layer 1), where the ACU measurement may be transmitted using a physical uplink control channel (PUCCH) or physical uplink shared channel (PUSCH). This approach provides fast reporting of the ACI measurements and the ACI measurements may in turn be reported more frequently and also upon request. Alternatively, the ACI measurements may be reported in the MAC layer, where the ACI measurement is reported in the MAC-CE of a PUSCH. The ACI measurements may also be reported in the RRC layer via an RRC measurement report.

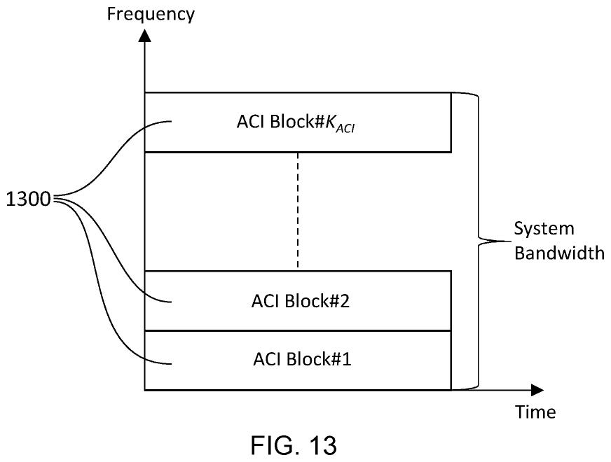

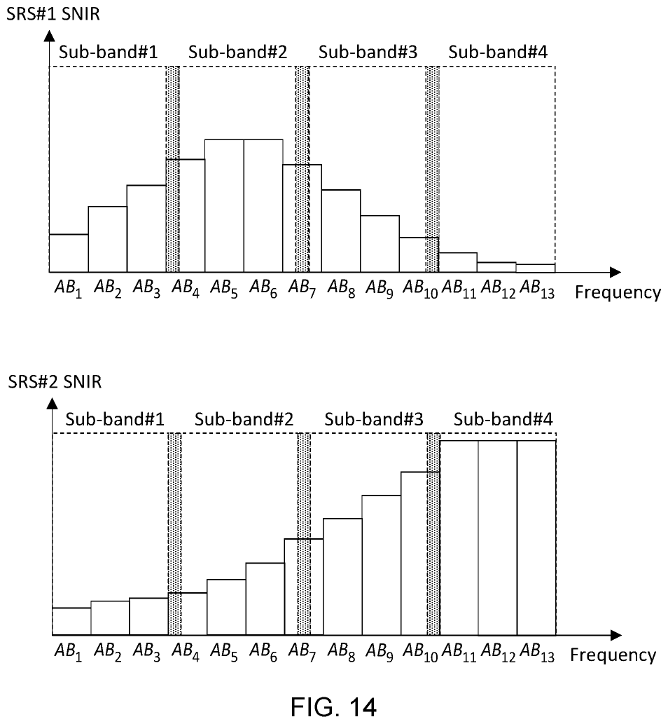

UE1 1110 may be configured to perform the ACI measurements in a plurality of frequency blocks across the system (i.e. gNB/UE) bandwidth. These frequency blocks are a set of contiguous frequency resource blocks (RBs) and may be referred to as ACI blocks, where UE1 1110 may report measurements for each ACI block. FIG. 13 shows an example of dividing a system bandwidth into ACI blocks 1300. Here, the bandwidth is divided into KACI ACI blocks 1300, i.e. {AB₁, AB₂, AB₃, . . . , AB₁₃}, where UE1 1110 performs the interference measurement for each ACI block 1300. FIG. 14 shows an example SNIR measurement by UE1 1110, where the system bandwidth is divided into 13 ACI blocks. The SRS #2 signal is transmitted by UE2 1120 on sub-band #4 704 and as such UE1 1110 measures a large SNIR value in ACI blocks AB₁₁, AB₁₂, and AB₁₃, which overlap with sub-band #4 704. The SNIR value measured gradually reduces from AB₁₀ to AB₁ as the measured frequency block becomes further from the transmission sub-band 701-704 frequency. UE1 1110 also measures the SNIR for the SRS #1 signal transmitted by UE3 1130 on sub-band #2 702. The SNIR result shows a peak corresponding to the transmission frequency at sub-band #2 702 (specifically ACI blocks AB₅ and AB₆), with the SNIR value decreasing for ACI blocks that are further away. In this example, UE3 1130 is further away from UE1 1110 than UE2 1120 and as such the peak SNIR value in an ACI block for UE2 1120 is larger than the peak SNIR value in an ACI block than UE3 1130.

Each ACI block may be smaller in width than the sub-bands 701-704 of the system bandwidth. That is the total range of frequencies may be narrower than the individual system sub-bands 701-704. Accordingly, use of ACI measurements provides finer granularity compared to legacy CLI measurements. This allows a gNB to make more informed decisions regarding which sub-bands 701-704 to assign for particular UEs within a cell in order to reduce ACI. For example, an ACI block that is close to an uplink sub-band 701-704 may experience interference that is tolerable and so rather than avoiding using that ACI block, the gNB can schedule a DL transmission to that block.

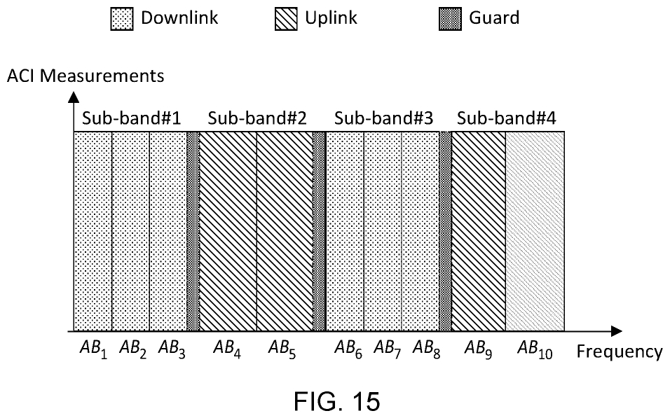

The size (i.e. frequency width) of each ACI block may be identical (as in FIG. 14), or in some cases the size of each ACI block may be individually configured. An example is shown in FIG. 15 where the ACI blocks are different sizes for uplink and downlink frequency sub-bands. That is, the ACI blocks may be arranged to align with particular sub-bands, where sub-bands reserved for downlink transmissions may include ACI blocks that are smaller in size than ACI blocks included within a sub-band that is reserved for uplink transmissions. In FIG. 15, sub-band #1 and sub-band #3 are reserved for downlink and contain 3 ACI blocks each, while sub-band #2 and sub-band #3 are reserved for uplink and contain 2 ACI blocks each. In this example, ACI blocks which overlap uplink sub-bands may be used to determine a relative distance between an aggressor UE and the victim UE, and as such these ACI blocks do not require as fine granularity. In contrast, as a gNB schedules DL signals to a UE in DL sub-bands it is beneficial to have finer granularity in these sub-bands to allow the gNB to make more informed scheduling decisions.

In some examples, ACI measurements may only be performed for ACI blocks in DL sub-bands. This may reduce the number of measurements and the amount of reporting performed by the UE (particularly when the DL and UL sub-bands are semi-statically configured). As such, performing measurements on UL sub-bands may not be beneficial as the UE is not going to receive any DL transmission in those bands and therefore will not experience CLI. Furthermore, in some examples ACI measurements may not be measured for ACI blocks that overlap (fully or mostly, e.g. 70%, 75%, 80%, 85%, 90%, 95% or higher) with guard sub-bands 710 (e.g. as shown in FIG. 7). Guard sub-bands 710 are used to isolate UL and DL transmissions from one another to mitigate against intra-cell CLI and as such are unlikely be used for DL scheduling.

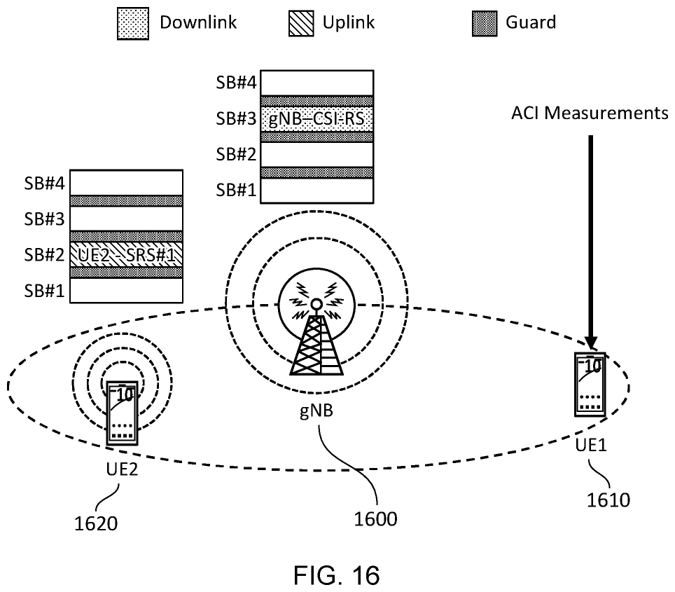

While in the example of FIG. 11 a UE measures SRS transmissions from two UEs, in some implementations a UE may instead measure an SRS transmission from a UE and a reference signal (e.g. a channel state information reference signal (CSI-RS)) from a gNB. An example is shown in FIG. 16, where UE2 1620 transmits a SRS #1 on sub-band #2 702, as in FIG. 11. In addition, the gNB 1600 transmits a CSI-RS on sub-band #3 703. Accordingly, UE1 1610 measures the level of interference and signal quality, for example by measuring a CQI based on the gNB's 1600 CSI-RS. However, as the CQI measurement is influenced by the SRS #1 transmitted by UE2 1620, UE1 1610 is able to report the results of the CQI measurement to the gNB 1600 on a per-SRS basis. That is, the CQI results can be reported to the gNB 1600 for each SRS transmission, and as such the gNB 1600 may be able to identify the effect of a specific UE (i.e. UE2 1620) on the CQI measurement. The gNB 1600 may then use this information when making scheduling decisions.

In some examples, the UE may additionally determine the path loss between the gNB and the UE and report the path loss to the gNB with the ACI measurements. That is, a UE that is close to the gNB will use less UL Tx power compared to one at the cell edge, and so the gNB may use this information together with the ACI block measurements when making scheduling decision. For example, the gNB may decide to pair (i.e. simultaneously schedule) a first UE close to the gNB for UL and a UE in the cell edge for DL. The UE may determine the pathloss between the UE and the gNB using any suitable known technique.

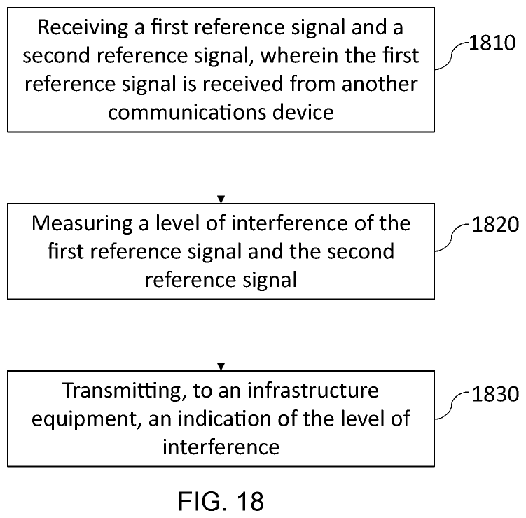

FIG. 18 shows a flow diagram of an example method for a communications device according to the present disclosure. At step 1810, the communications device receives, from an infrastructure equipment, a first reference signal and a second reference signal, wherein the first reference signal is received from another communications device. The method proceeds to step 1820 of measuring a level of interference of the first reference signal and the or more second reference signal. The method then includes step 1830 of transmitting, to an infrastructure equipment, an indication of the level of interference.

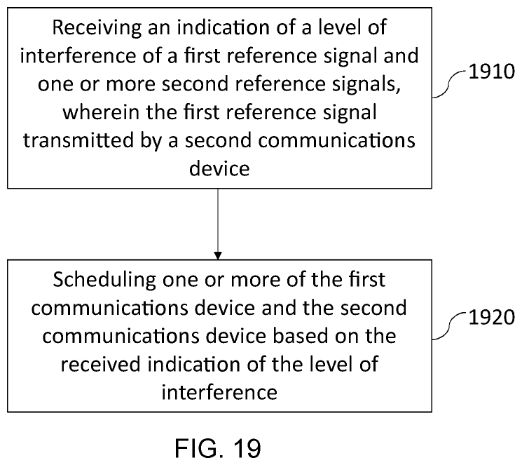

FIG. 19 shows a flow diagram of an example method for an infrastructure equipment according to the present disclosure. The method includes step 1910 of receiving, from a communications device, an indication of a level of interference of a first reference signal and one or more second reference signals, wherein the first reference signal transmitted by a second communications device. The method then proceeds to step 1920 of scheduling one or more of the first communications device and the second communications device based on the received indication of the level of interference.

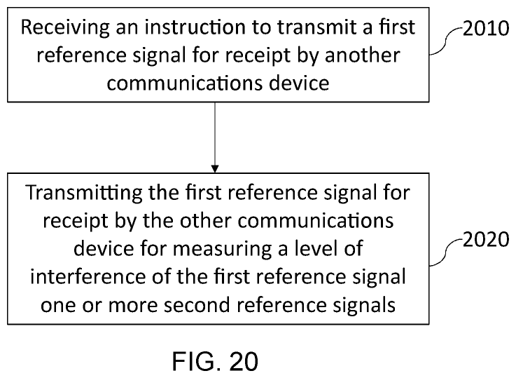

FIG. 20 illustrates a flow diagram of an example method for a communications device according to the present disclosure. The method includes step 2010 of receiving an instruction to transmit a first reference signal. The method then proceeds to step 2020 of transmitting the first reference signal for receipt by the other communications device for measuring a level of interference of the first reference signal one or more second reference signals.

The following numbered clauses provide further example aspects and features of the present technique:

1. A method for a communications device, the method comprising:
receiving a first reference signal and one or more second reference signals, wherein the first reference signal is received from another communications device;
measuring a level of interference of the first reference signal and the one or more second reference signals; and
transmitting, to an infrastructure equipment, an indication of the level of interference.
   2. The method according to clause 1, wherein the communications device measures the level of interference over a bandwidth of the communications device.
   3. The method according to clause 2, wherein the bandwidth of the communications device comprises a plurality of sub-bands.
   4. The method according to clause 3, wherein each of the plurality of sub-bands are reserved for a particular one of downlink and uplink transmissions.
   5. The method according to clause 4, wherein adjacent sub-bands of the plurality of sub-bands are reserved for different ones of downlink and uplink transmissions.
   6. The method according to any of clauses 3-5, wherein the bandwidth further comprises one or more guard sub-bands located between adjacent sub-bands of the plurality of sub-bands, wherein downlink and uplink transmissions are disabled in the one or more guard sub-bands.
   7. The method according to any preceding clause, wherein the communications device measures the level of interference in a plurality of frequency blocks across a bandwidth of the communications device.
   8. The method according to clause 7, wherein one or more frequency blocks of the plurality of frequency blocks span two or more sub-bands of the bandwidth of the communications device.
   9. The method according to clause 7 or clause 8, wherein the communication device measures the level of interference in a subset of frequency blocks, wherein the subset of frequency blocks are included in a downlink-only sub-band of the bandwidth of the communications device.
   10. The method according to any of clauses 7-9, wherein the communication device measures the level of interference in a subset of frequency blocks, wherein the subset of frequency blocks do not substantially overlap with a guard sub-band of the bandwidth of the communications device.
   11. The method according to any preceding clause, wherein the communications device measures the level of interference by performing a measurement of signal to noise plus interference ratio, SNIR.
   12. The method according to any preceding clause, wherein the communications device measures the level of interference by determining a channel quality indicator, CQI, based on the first and the one or more second reference signals.
   13. The method according to any preceding clause, wherein the communications device measures the level of interference by determining a received signal power for each of the first and the one or more second reference signals.
   14. The method according to any preceding clause, wherein the one or more second reference signals includes a signal received from a third communications device.
   15. The method according to any preceding clause, wherein the one or more second reference signals includes a signal received from the infrastructure equipment.
   16 The method according to any preceding clause, further comprising:
determining a pathloss between the communications device and the infrastructure equipment; and
transmitting, to the infrastructure equipment, the pathloss with the indication of the level of interference.
   17. A communications device comprising:
a transceiver configured to transmit signals to and/or to receive signals from an infrastructure equipment of a wireless communications network via a wireless radio interface provided by the wireless communications network, and
a controller configured in combination with the transceiver to:
   receive a first reference signal and one or more second reference signals, wherein the first reference signal is received from another communications device;
   measure a level of interference of the first reference signal and the one or more second reference signals; and
   transmit, to an infrastructure equipment, an indication of the level of interference.
      18. Circuitry for a communications device comprising:
transceiver circuitry configured to transmit signals to and/or to receive signals from an infrastructure equipment of a wireless communications network via a wireless radio interface provided by the wireless communications network, and
controller circuitry configured in combination with the transceiver circuitry to:
   receive a first reference signal and one or more second reference signals, wherein the first reference signal is received from another communications device;
   measure a level of interference of the first reference signal and the one or more second reference signals; and
   transmit, to an infrastructure equipment, an indication of the level of interference.
      19. A method for an infrastructure equipment, the method comprising:
receiving, from a first communications device, an indication of a level of interference of a first reference signal and one or more second reference signals, wherein the first reference signal transmitted by a second communications device; and
scheduling one or more of the first communications device and the second communications device based on the received indication of the level of interference.
   20. The method according to clause 19, wherein the level of interference is a level of interference at the first communications device, measured by the first communications device.
   21. The method according to clause 19 or clause 20, wherein the indication of the level of interference indicates a level of interference over a bandwidth of the communications device.
   22. The method according to clause 21, wherein the bandwidth of the communications device comprises a plurality of sub-bands.
   23. The method according to clause 22, wherein each of the plurality of sub-bands are reserved for a particular one of downlink and uplink transmissions.
   24. The method according to clause 23, wherein adjacent sub-bands of the plurality of sub-bands are reserved for different ones of downlink and uplink transmissions.
   25. The method according to any of clauses 22-24, wherein the bandwidth further comprises one or more guard sub-bands located between adjacent sub-bands of the plurality of sub-bands, wherein downlink and uplink transmissions are disabled in the one or more guard sub-bands.
   26. The method according to any of clauses 19-25, wherein the indication of the level of interference includes an indication of a level of interference in a plurality of frequency blocks across the bandwidth of the communications device.
   27. The method according to clause 26, wherein one or more frequency blocks of the plurality of frequency blocks span two or more sub-bands of the bandwidth of the communications device.
   28. The method according to clause 26 or clause 27, wherein indication of the level of interference comprises a level of interference in a subset of frequency blocks, wherein the subset of frequency blocks are included in a downlink-only sub-band of the bandwidth of the communications device.
   29. The method according to any of clauses 26-28, wherein the indication of the level of interference comprises a level of interference in a subset of frequency blocks, wherein the subset of frequency blocks do not substantially overlap with a guard sub-band of the bandwidth of the communications device.
   30. The method according to any of clauses 19-29, wherein the indication of the level interference comprises a signal to noise plus interference ratio, SNIR, value.
   31. The method according to any of clauses 19-30, wherein the indication of the level interference comprises a channel quality indicator, CQI, based on the first and the one or more second reference signals.
   32. The method according to any of clauses 19-31, wherein the indication of the level interference comprises a received signal power for each of the first and the one or more second reference signals.
   33. The method according to any of clauses 19-32, wherein the one or more second reference signals includes a signal transmitted by a third communications device.
   34. The method according to any of clauses 19-33, wherein the one or more second reference signals includes a signal transmitted by the infrastructure equipment.
   35. The method according to any of clauses 19-34, further comprising:
determining a pathloss between the first communications device and the infrastructure equipment, wherein scheduling one or more of the first communications device and the second communications device is additionally based on the pathloss.
   36 The method according to any of clauses 19-35, wherein the scheduling comprises scheduling one or more of the first communications device and the second communications device for one or more uplink and/or downlink transmissions based on the received indication of the level of interference.
   37. The method according to clause 36, wherein the infrastructure equipment schedules one or more of the first communications device and the second communications device for one or more uplink and/or downlink transmissions in a particular sub-band of a bandwidth based on the received indication of the level of interference.
   38. An infrastructure equipment comprising:
a transceiver configured to transmit signals to and/or to receive signals from a communications device via a wireless radio interface provided by the infrastructure equipment, and
a controller configured in combination with the transceiver to:
   receive, from a first communications device, an indication of a level of interference of a first reference signal and one or more second reference signals, wherein the first reference signal transmitted by a second communications device; and
   schedule one or more of the first communications device and the second communications device based on the received indication of the level of interference.
      39. Circuitry for an infrastructure equipment, the circuitry comprising:
transceiver circuitry configured to transmit signals to and/or to receive signals from a communications device via a wireless radio interface provided by the infrastructure equipment, and
controller circuitry configured in combination with the transceiver circuitry to:
   receive, from a first communications device, an indication of a level of interference of a first reference signal and one or more second reference signals, wherein the first reference signal transmitted by a second communications device; and
   schedule one or more of the first communications device and the second communications device based on the received indication of the level of interference.
      40. A method for a communications device, the method comprising:
receiving, from an infrastructure equipment, an instruction to transmit a first reference signal; and
transmitting the first reference signal for use by another communications device for measuring a level of interference between the first reference signal one or more second reference signals.
   41. The method according to clause 40, further comprising:
receiving, from the infrastructure equipment, scheduling instructions, wherein the scheduling instructions are based on the of interference of the first reference signal and one or more second reference signals.
   42. A communications device comprising:
a transceiver configured to transmit signals to and/or to receive signals from an infrastructure equipment of a wireless communications network via a wireless radio interface provided by the wireless communications network, and
a controller configured in combination with the transceiver to:
   receive, from an infrastructure equipment, an instruction to transmit a first reference signal; and
   transmit the first reference signal for use by another communications device for measuring a level of interference between the first reference signal one or more second reference signals.
      43. Circuitry for a communications device comprising:
transceiver circuitry configured to transmit signals to and/or to receive signals from an infrastructure equipment of a wireless communications network via a wireless radio interface provided by the wireless communications network, and
controller circuitry configured in combination with the transceiver circuitry to:
   receive, from an infrastructure equipment, an instruction to transmit a first reference signal; and
transmit the first reference signal for use by another communications device for measuring a level of interference between the first reference signal one or more second reference signals.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LTE for UMTS OFDMA and SC-FDMA based radio access”, John Wiley and Sons, 2009.
[2] RP-213591, “New SI: Study on evolution of NR duplex operation,” CMCC, RAN #94e

1. A method for a communications device, the method comprising:
receiving a first reference signal and one or more second reference signals, wherein the first reference signal is received from another communications device;
measuring a level of interference of the first reference signal and the one or more second reference signals; and
transmitting, to an infrastructure equipment, an indication of the level of interference.

2. The method according to claim 1, wherein the communications device measures the level of interference over a bandwidth of the communications device.

3. The method according to claim 2, wherein the bandwidth of the communications device comprises a plurality of sub-bands.

4. The method according to claim 3, wherein each of the plurality of sub-bands are reserved for a particular one of downlink and uplink transmissions.

5. The method according to claim 4, wherein adjacent sub-bands of the plurality of sub-bands are reserved for different ones of downlink and uplink transmissions.

6. The method according to claim 3, wherein the bandwidth further comprises one or more guard sub-bands located between adjacent sub-bands of the plurality of sub-bands, wherein downlink and uplink transmissions are disabled in the one or more guard sub-bands.

7. The method according to claim 1, wherein the communications device measures the level of interference in a plurality of frequency blocks across a bandwidth of the communications device.

8. The method according to claim 7, wherein one or more frequency blocks of the plurality of frequency blocks span two or more sub-bands of the bandwidth of the communications device.

9. The method according to claim 7, wherein the communication device measures the level of interference in a subset of frequency blocks, wherein the subset of frequency blocks are included in a downlink-only sub-band of the bandwidth of the communications device.

10. The method according to claim 7, wherein the communication device measures the level of interference in a subset of frequency blocks, wherein the subset of frequency blocks do not substantially overlap with a guard sub-band of the bandwidth of the communications device.

11. The method according to claim 1, wherein the communications device measures the level of interference by performing a measurement of signal to noise plus interference ratio, SNIR.

12. The method according to claim 1, wherein the communications device measures the level of interference by determining a channel quality indicator, CQI, based on the first and the one or more second reference signals.

13. The method according to claim 1, wherein the communications device measures the level of interference by determining a received signal power for each of the first and the one or more second reference signals.

14. The method according to claim 1, wherein the one or more second reference signals includes a signal received from a third communications device.

15. The method according to claim 1, wherein the one or more second reference signals includes a signal received from the infrastructure equipment.

16. The method according to claim 1, further comprising:
determining a pathloss between the communications device and the infrastructure equipment; and
transmitting, to the infrastructure equipment, the pathloss with the indication of the level of interference.

17. A communications device comprising:
a transceiver configured to transmit signals to and/or to receive signals from an infrastructure equipment of a wireless communications network via a wireless radio interface provided by the wireless communications network, and
a controller configured in combination with the transceiver to:
receive a first reference signal and one or more second reference signals, wherein the first reference signal is received from another communications device;
measure a level of interference of the first reference signal and the one or more second reference signals; and
transmit, to an infrastructure equipment, an indication of the level of interference.

18.-37. (canceled)

38. An infrastructure equipment comprising:
a transceiver configured to transmit signals to and/or to receive signals from a communications device via a wireless radio interface provided by the infrastructure equipment, and
a controller configured in combination with the transceiver to:
receive, from a first communications device, an indication of a level of interference of a first reference signal and one or more second reference signals, wherein the first reference signal transmitted by a second communications device; and
schedule one or more of the first communications device and the second communications device based on the received indication of the level of interference.

39.-43. (canceled)
